(19) United States
(12) Patent Application Publication
(10) Pub. No.: US 2008/0237954 A1
(43) Pub. Date: Oct. 2, 2008

(54) DAMPER APPARATUS

(76) Inventor: Masaki SAKAI, Fukuroi-shi (JP)

Correspondence Address: MILES & STOCKBRIDGE PC, 1751 PINNACLE DRIVE, SUITE 500, MCLEAN, VA, 22102-3833, US

(21) Appl. No.: 12/057,336

(22) Filed: Mar. 27, 2008

(30) Foreign Application Priority Data
Mar. 29, 2007 (JP) 2007-087086

(51) Int. Cl. F16F 1/14

(52) U.S. Cl. 267/154

(57) ABSTRACT

The present invention provides a damper apparatus mounted between an engine and a transmission and adapted to dampen vibration by a torsion spring, in which a film of a diamond-like carbon is formed on a metal member which is slidably contacted with the torsion spring.

### BACKGROUND OF THE INVENTION

1. Field of the Invention

The present invention relates to a damper apparatus used in a torque converter or a starting clutch utilized together with an automatic transmission of a vehicle and the like and adapted to be disposed between an engine and a transmission to dampen vibration.

2. Description of the Related Art

A conventional damper assembly serves to absorb or dampen vibration generated between an engine and a transmission, by utilizing a torsion spring or elasticity of the torsion spring used in a damper as disclosed in Japanese Patent Application Laid-open No. 2000-329197.

However, in the damper disclosed in the above-mentioned Japanese Patent Application Laid-open No. 2000-329197, a slider and a torsion spring mounted between the engine and the transmission are contacted with a housing provided on an outer diameter portion with a strong force, due to a centrifugal force generated by a high speed rotation. Thus, smooth elongation and contraction of the torsion spring are obstructed, thereby causing problems that it affects a bad influence upon the vibration damping ability of the damper and that contacting parts are worn.

### SUMMARY OF THE INVENTION

Accordingly, an object of the present invention is to provide a reliable damper apparatus which allows a smooth swinging or twisting movement of a sliding member by reducing a friction force generated by increase in face pressure between the sliding members as a result of a centrifugal force caused by a rotation of a damper and which can prevent wear caused by the sliding movement of a sliding surface without affecting a bad influence upon a vibration damping effect.

To achieve the above object, the present invention provides a damper apparatus mounted between an engine and a transmission and adapted to dampen vibration by utilizing a torsion spring, in which a film of a diamond-like carbon is formed on a metal member which is slidably contacted with a the torsion spring.

According to the damper apparatus according to the present invention, the following effect can be obtained.

Since the film of the diamond-like carbon is coated on the metal member to which a friction force generated by the sliding movement of the torsion spring used in the damper apparatus is transmitted, the friction force caused by increase in face pressure between the sliding portions due to a centrifugal force generated the rotation of the damper can be reduced, thereby achieving smooth sliding movement of the sliding member.

As a result, the vibration damping effect of the damper apparatus is not obstructed and the wear caused by the sliding movement of the sliding surface can be prevented, thereby enhancing the reliability of the damper apparatus.

It is desirable that a thickness of the film of the diamond-like carbon is selected to be 0.1 μm to 5 μm. If the thickness is smaller than 1 μm, an endurance life for the wear will become short, and if the thickness is greater than 5 μm, the film will become fragile thereby to increase the manufacturing cost.

Further features of the present invention will become apparent from the following description of exemplary embodiments with reference to the attached drawings.

### BRIEF DESCRIPTION OF THE DRAWINGS

FIG. 1 is a front view showing a damper apparatus which can be applied to various embodiments of the present invention.

FIG. 2 is a sectional view taken along the line A-A in FIG. 1.

### DESCRIPTION OF THE EMBODIMENTS

Now, various embodiments of the present invention will be fully explained with reference to the accompanying drawings. Incidentally, it should be noted that the illustrated embodiments are merely examples of the present invention and that various alterations can be made.

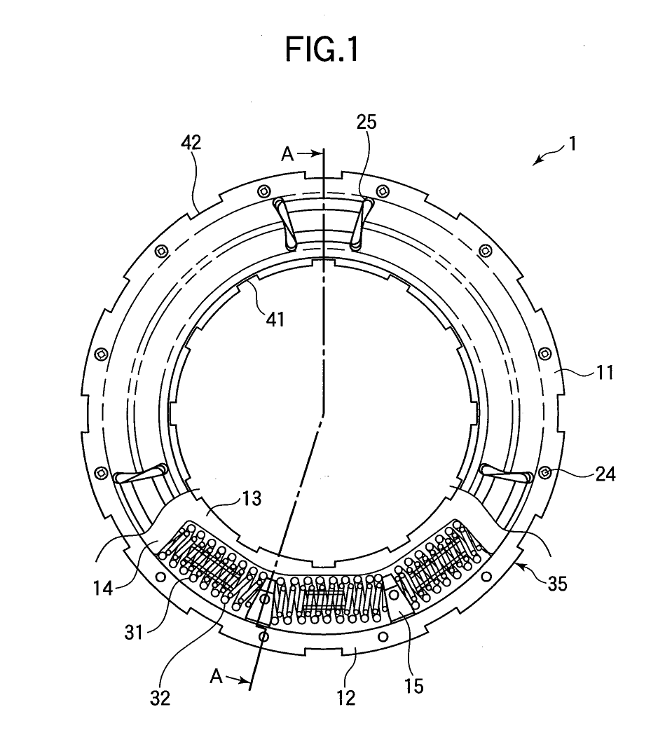

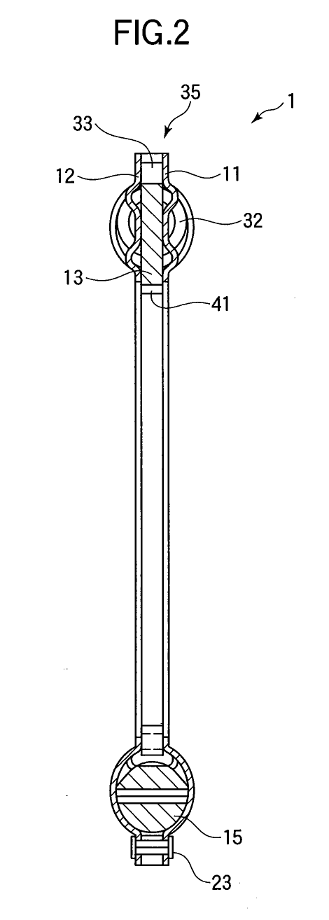

FIG. 1 is a front view showing a damper apparatus which can be applied to various embodiments of the present invention, and FIG. 2 is a sectional view taken along the line A-A in FIG. 1.

A damper apparatus 1 comprises a pair of substantially annular opposed retainer plates 11 and 12, and a ring 33. The damper apparatus 1 includes a holder 35 provided at its outer periphery with a plurality of splines 42 equidistantly disposed along a circumferential direction.

Plural sets of large and small springs 31 and 32 arranged substantially equidistantly along a circumferential direction at predetermined positions on a circumference of a cavity defined by the holder 35. The springs 31 and 32 are coil springs having predetermined spring constants, respectively and the small diameter spring 31 is fitted in the large diameter spring 32. The springs 31 and 32 are coil-type torsion springs, respectively.

The damper apparatus 1 further includes a plurality of slider members 15 disposed between a substantially annular drive plate 13 having pawls 14 elastically engaged by the springs 31, 32 and also having a plurality of splines 41 provided at its inner periphery and arranged substantially equidistantly along a circumferential direction and the plural springs 31, 32, which slider members can be shifted within the cavity formed in the holder 35.

The damper apparatus 1 is attached to associated members by fitting one of the associated members on outer peripheral splines 42 of the damper apparatus and by fitting the other associated member into the inner peripheral splines 41. Further, the retainer plates 11, 12 and the ring 33 are integrally secured to each other by inserting rivets 23 into respective axial through-holes 24. As shown in FIG. 1, a plurality of through-holes 24 is arranged substantially equidistantly along the circumferential direction. Further, since smaller rivets 23 than conventional ones are used, radial widths of the retainer plates 11 and 12 can be reduced.

Each of the retainer plates 11 and 12 has a plurality of bent portions 25 adapted to regulate shifting movements of the springs 31 and 32 and arranged at predetermined positions along the circumferential direction so that, when the torque is transmitted, if vibration is generated between the holder 35 and the substantially annular drive plate 13, the springs 31 and 32 are contracted between the pawls 14 and the bent portions 25, thereby absorbing the vibration.

In the above-mentioned embodiment, although the splines are provided in the outer periphery of the holder 35 and in the inner periphery of the drive plate 13 having the pawls 14, a reverse arrangement can be adopted. That is to say, the pawls 14 may be formed on the inner periphery of the drive plate 13 and the splines may be formed in the outer periphery of the drive plate 13, whereas, with respect the holder 35, the ring and the retainer plates may be secured to each other at an inner peripheral side and the splines may be formed in the inner peripheral side, thereby obtaining the damper apparatus of the present invention. Further, the outer splines may be formed on the ring 33 in a condition that the diameters of the retainer plates are decreased and the diameter of the ring 33 is increased.

### First Embodiment

In the damper apparatus 1 having the construction shown in FIGS. 1 and 2, the films of the diamond-like carbon (referred to as “DLC film(s)” hereinafter for clarifying the explanation) are formed on surfaces of the retainer plates 11, 12 and the drive plate 13, which are metal members slidably contacted with the springs 31 and 32.

Although the DLC films may be formed on the surfaces of all of the retainer plate 11, retainer plate 12 and drive plate 13, the DLC films may be formed on the retainer plate 11 and the retainer plate 12 alone, on the drive plate 13 alone or on only one of these three metal members.

### Second Embodiment

In the damper apparatus 1 having the construction shown in FIGS. 1 and 2, the DLC films are formed on surfaces of the springs 31 and 32 slidably contacted with the metal members such as the retainer plate 11, retainer plate 12 and drive plate 13.

Although the DLC films may be formed on the surfaces of both of the springs 31 and 32, the DLC films may be formed on only the surface of the spring 32 having a greater surface area slidably contacted with the associated with the metal members.

### Third Embodiment

In the damper apparatus 1 having the construction shown in FIGS. 1 and 2, the DLC films are formed on surfaces of the plurality of slider members 15 disposed between the plural springs 31 and 32 and equidistantly arranged along the circumferential direction for the shifting movement in the cavity of the holder 35.

By applying the DLC films onto the slider members 15 which are more slidably worn than the other members, the vibration damping and the wear prevention, which are the effects to be achieved by the present invention, can be achieved more effectively.

In the above-mentioned embodiments, the DLC films are formed on all of the surfaces of the metal members such as the retainer plate 11, retainer plate 12 and drive plate 13, the springs 31, springs 32 and the slider members 15. However, the DLC films may be formed on portions of the surfaces.

Further, by combining the embodiments, the DLC films may be formed on all of the metal members such as the retainer plate 11, retainer plate 12 and drive plate 13, the springs 31, springs 32 and the slider members 15. Further, the first embodiment and the second embodiment, the first embodiment and the third embodiment, and the second embodiment and the third embodiment may be combined.

Further, the DLC film is formed a plasma CVD (chemical vapor deposition) method or a PVD (physical vapor deposition) method.

The above-mentioned damper apparatus can be used with a lock-up piston of a torque converter used in an automatic transmission of a vehicle, for example. Further, the damper apparatus can also be used as a damper apparatus for a starting clutch.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-087086, filed Mar. 29, 2007, which is hereby incorporated by reference herein in its entirety.

What is claimed is:

1. A damper apparatus mounted between an engine and a transmission and adapted to dampen vibration by a torsion spring wherein:
a film of a diamond-like carbon is formed on a metal member which is slidably contacted with said torsion spring.

2. A damper apparatus according to claim 1, wherein said metal member is a retainer plate and/or a drive plate for holding said torsion spring.

3. A damper apparatus mounted between an engine and a transmission and adapted to dampen vibration by a torsion spring wherein:
a film of a diamond-like carbon is formed on said torsion spring.

4. A damper apparatus according to claim 3, wherein the film is formed on a metal member which is slidably contacted with said torsion spring.

5. A damper apparatus mounted between an engine and a transmission and adapted to dampen vibration by torsion springs wherein:
a film of a diamond-like carbon is formed on a slider member mounted between said torsion springs.

6. A damper apparatus according to claim 5, wherein the film is formed on said torsion springs.

7. A damper apparatus according to claim 5, wherein the film is formed on a metal member which is slidably contacted with said torsion spring.
